(19) United States
(12) Patent Application Publication
(10) Pub. No.: US 2005/0087490 A1
(43) Pub. Date: Apr. 28, 2005

(54) Process for removing impurities from low dielectric constant films disposed on semiconductor devices

(75) Inventors: Mark S. Chace, Beacon, NY (US); Jeffrey C. Hedrick, Montvale, NJ (US); Habib Hichri, Wappingers Falls, NY (US); Keith R. Pope, Danbury, CT (US); Jia Lee, Ossining, NY (US); Kelly Malone, Poughkeepsie, NY (US); Kenneth J. McCullough, Fishkill, NY (US); Wayne Moreau, Wappingers Falls, NY (US); Darryl D. Restaino, Modena, NY (US); Shahab Siddiqui, Wappingers Falls, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 10/695,374

(22) Filed: Oct. 28, 2003

(51) Int. Cl. B01D 11/00

(52) U.S. Cl. 210/634; 210/639; 438/99

(57) ABSTRACT

A process of removing impurities from a cured low dielectric constant organic polymeric film disposed on a semiconductor device. The process involves disposing a low dielectric constant curable organic polymeric film on an electrically conductive surface of a semiconductor device. The organic polymeric film is cured on the semiconductor device and thereupon contacted with supercritical carbon dioxide, optionally in the presence of at least one cosolvent.

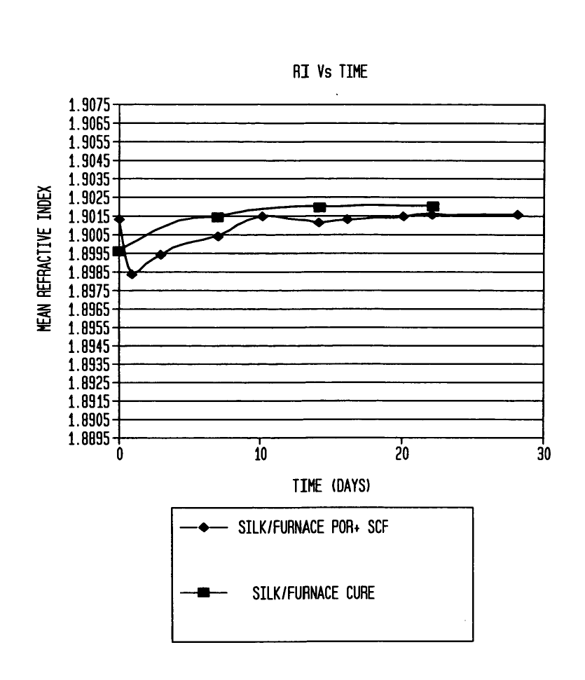

### BACKGROUND OF THE DISCLOSURE

1. Field of the Invention

The present invention relates to a process for degassing cured low dielectric constant insulating films employed in microelectronic devices. More particularly, the present invention is directed to a process of removing residual solvents, unreacted monomers and byproducts of curing from dielectric films disposed on semiconductor devices by contacting the dielectric film with supercritical carbon dioxide with or without other cosolvents.

2. Background of the Prior Art

The semiconductor industry drive to continually improve performance and increase circuit density has resulted in the use of advanced materials and interconnect structures. High interconnect performance requires reduction in resistance and capacitance.

Until recent years silicon dioxide was the dielectric insulator of choice for the semiconductor industry. Silicon dioxide possesses excellent dielectric breakdown strength, high modulus, good thermal conductivity, low coefficient of thermal expansion and excellent adhesion to metallic liners, plasma enhanced chemical vapor deposited (PECVD) barrier capped layers and other materials. However, with the continual reduction in size, silicon dioxide is being slowly phased out of use and replaced with materials possessing lower dielectric constant. For example, at the 180 nm technology mode, fluorosilicate glass is replacing silicon dioxide in many applications.

It is, however, at the 130 nm technology generation that low-k dielectrics are essential to effective operation of semiconductor products. These new insulators have dielectric constants below that of about 4, which is the dielectric constant of silicon dioxide. Probably the most popular and effective class of low-k dielectrics now being employed in the semiconductor industry is spin-on organic polymers.

These polymers offer properties not previously obtainable by dielectrics employed in the past. Unfortunately, one of the problems associated with the use of this new generation of low dielectric organic polymers is the compromise to their effectiveness, in terms of low dielectric constant, as well as adhesion to the metal surfaces between which they are disposed, in semiconductor arrays, caused by the presence of foreign materials such as solvents, unreacted monomers and byproducts.

At present, the preferred fluid for removal of these impurities is deionized water. The deionized water entrains undesirable byproducts formed during curing and post reaction ion etching (RIE). However, the absorption of water by the organic dielectric polymer leads to reliability and time dependent dielectric breakdown (TDBB) failures.

An alternate method employed to remove impurities and foreign materials from organic polymer low dielectric films employed in semiconductor devices involves heating the semiconductor device at elevated temperature. Although this method is effective in removing solvents and unreacted monomers, the vaporization temperatures of byproducts is sufficiently high so that this method is ineffectual in removing these undesirable foreign ingredients.

Although the use of supercritical fluids in the processing of semiconductor devices is known in the art, the removal of foreign components from cured organic polymer dielectric insulating films by utilizing supercritical fluids is unknown. Of interest, however, is the disclosure in U.S. Pat. Nos. 5,908,510 and 5,976,264, the latter patent issuing from a the divisional application of the application that issued as the '510 patent. The disclosure of these patents addresses the removal of halogenated etched residue from a reactive ion etched (RIE) precision surface by a fluid exposed to supercritical thermodynamic conditions.

U.S. Pat. No. 6,346,484 is directed to the use of a supercritical fluid to extract sacrificial materials from a semiconductor structure to form air gaps. The supercritical fluid, which has substantially no surface tension, permits the introduction of the fluid into openings which otherwise could not be penetrated by usual solvents.

The above remarks establish the absence in the art of a method for removal of foreign materials from a cured organic polymer low dielectric constant film employed in semiconductor devices. Thus, there is a strong need in the art for a method of foreign material removal consistent with the retention of the desirable properties associated with the use of low dielectric constant organic films in semiconductor devices.

### BRIEF SUMMARY OF THE INVENTION

A new method has now been discovered for the removal of residual solvents, unreacted monomers and byproducts from cured low dielectric constant organic polymeric films disposed on semiconductor devices which results in lower dielectric constant properties than those associated with these low dielectric constant films not subject to adequate solvent extraction removal processes as well as greater adhesion of the film to the metal surfaces insulated by the cured organic polymeric film.

In accordance with the present invention a process of removing residual solvents, unreacted monomers and byproducts from cured low dielectric constant organic polymeric films is disclosed. In this process a curable low dielectric constant organic polymeric film is disposed on a semiconductor device; the polymeric film is cured; and the cured film is contacted, under supercritical thermodynamic conditions, with carbon dioxide, optionally, including one or more additional solvents. This contact results in removal of residual solvents, unreacted monomers and, especially, higher boiling point byproducts from the cured organic polymeric film. This contact results in a lower dielectric constant product having excellent adherence to metal surfaces between which the low dielectric film is disposed so that good insulation as well as excellent reliability against shorting and the like resulting from inadequate electrical resistance and adhesion of the film.

### BRIEF DESCRIPTION OF THE DRAWING

The present invention may be better understood with reference to the accompanying drawing which is a plot of mean refractive index as a function of time for cured low dielectric constant organic polymers processed in accordance with Example 1 and Comparative Example 1 of the working examples.

### DETAILED DESCRIPTION

Cured low dielectric constant organic polymers have recently been developed in order to coincide with the continuing decrease in semiconductor device size. That is, cured organic polymers having very low dielectric constants have been developed so that the thickness of the organic polymer film layer, disposed between conductive layers, which these polymers insulate, is sufficiently thin to accommodate the very low nanometer size required of this new generation of semiconductor devices.

In view of the more stringent requirements of cured low dielectric constant organic polymers, for such uses as interlevel dielectrics and interleave dielectrics in semiconductor devices, not only is it essential that new and lower dielectric constant curable organic polymer films be developed but, in addition, new and better methods for their purification is essential.

One major class of organic polymers useful as low dielectric constant cured films are polyarylene resins. The term “polyarylene” is used herein to denote aryl moieties or inertly substituted aryl moieties which are linked together by bonds, fused rings or inert linking groups, such as oxygen, sulfur, sulfone, sulfoxide, carbonyl and the like. The precursor composition for the polyarylene may comprise monomers, oligomers or mixtures thereof. Preferably, the precursor composition comprises cyclopentadienone functional groups and acetylene functional aromatic compounds and/or partially polymerized reaction products of such compounds.

The most preferred precursor compositions employed in the present invention comprise the following monomers and/or partially polymerized reaction products of the following monomers:
(a) a biscyclopentadienone of the formula: 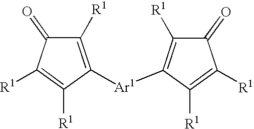
(b) a polyfunctional acetylene of the formula: 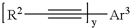
(c) and, optionally, a diacetylene of the formula:
R²Ar²R²
wherein R¹ and R² are, independently, H or an unsubstituted or inertly-substituted aromatic moiety; Ar¹, Ar² and Ar³ are, independently, an unsubstantiated aromatic moiety or inertly-substituted aromatic moiety; and y is an integer of three or more.

Stated differently, the particularly preferred precursor material comprises a curable polymer of the formula:
[A]_{w}[B]_{z}[EG]ᵥ
wherein A has the structure: 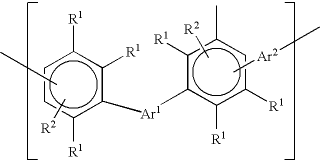
B has the structure: 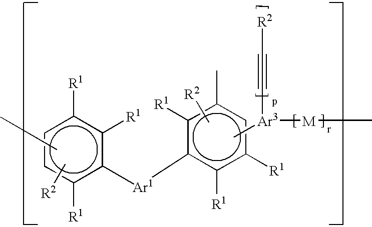
and endgroups EG are independently represented by any one of the formulae: 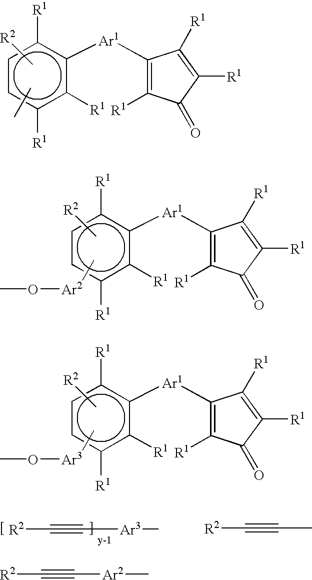
wherein R¹ and R² are, independently, H or an unsubstituted or inertly-substituted aromatic moiety; Ar¹, Ar² and Ar³ are, independently, an unsubstantiated aromatic moiety or inertly-unsubstituted aromatic moiety; M is a bond; y is an integer of three or more; p is the number of unreacted acetylene groups in the given mer unit; r is one less than the number of reacted acetylene groups in the given mer unit where p+r=y−1; z is an integer from 1 to about 1000; w is an integer from 0 to about 1000; and v is an integer of two or more.

Those skilled in the art will be aware that a carbon atom is understood to be present between R² and Ar³ or Ar² in order for there to be an acetylenic bond therebetween.

The definition of an aromatic moiety includes phenyl, polyaromatic and fused aromatic moieties. Inertly-substituted means the substituent groups are essentially inert to the cyclopentadienone and acetylene polymerization reactions and do not readily react under the conditions of use of the cured polymer in microelectronic devices with environmental species such as water. Such substituent groups include, for example, F, Cl, Br, —CF₃, —OCH₃, —OCF₃, —O-Ph, alkyl of from one to eight carbon atoms and cycloalkyl of from three to about eight carbon atoms. For example, the moieties which can be unsubstituted or inertly-substituted aromatic moieties include: 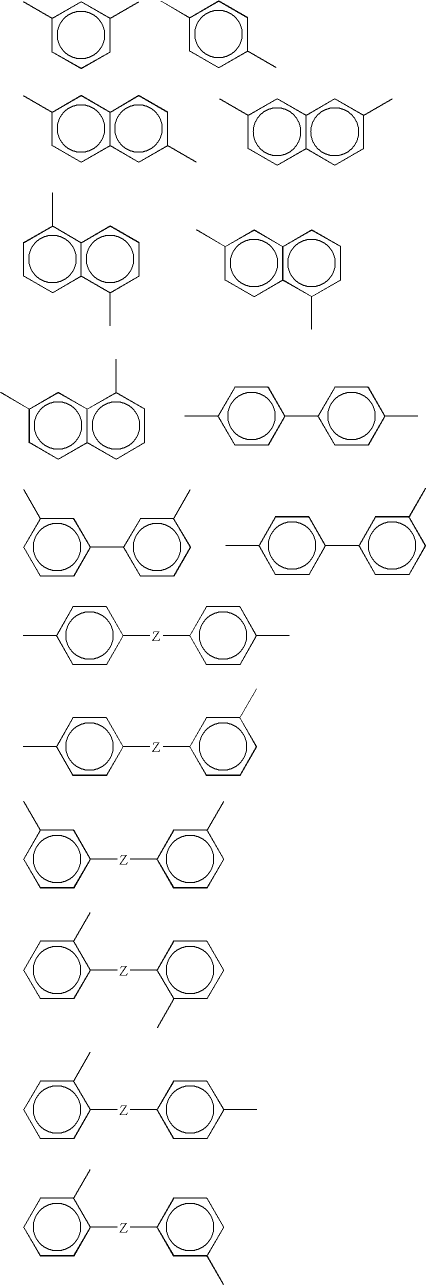 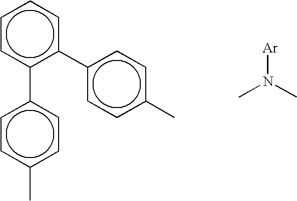
where Ar is an aromatic moiety as defined above; and Z can be: —O—, —S—, alkylene, —CF₂—, —CH₂—, —O—CH₂—, perfluoroalkyl, perfluoroalkoxy, 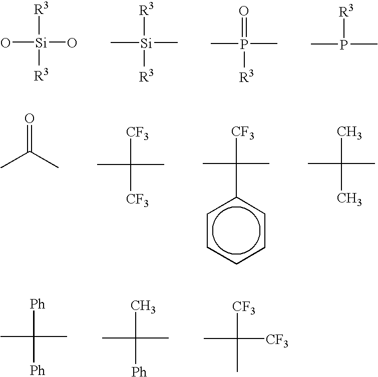
wherein each R³ is independently —H, —CH₃, —CH₂CH₃, —(CH₂)₂CH₃ or Ph. It should be appreciated that Ph is phenyl.

A highly preferred thermosetting resin employed in the present invention is a polyarylene resin sold under the tradename SiLK® by Dow Chemical Co. SiLK® is the resultant cured b-staged Diels Alder reaction product of a biscyclopentadienone and a polyfunctional acetylene. Commercially available examples of some other preferred polyarylene resins include SiLK®-H, and SiLK®-I dielectric resins from Dow Chemical Company.

Another class of preferred polymers useful as ILDs, which is advantageously treated with supercritical carbon dioxide in accordance with the present invention, is the class of polymers known as poly(silsesquioxanes). Poly(silsesquioxanes) are polymers obtained from trialkyloxysilanes. The most common of these polymers are poly(methylsilsesquioxane), which is often referred to as MSQ, available commercially as Accuspin T-18® from Allied Signal, and poly(hydridosilsesquioxane), referred to as HSQ, available commercially from Dow Corning as FOx®.

Poly(methylsilsesquioxane) upon curing has the repeating structural unit 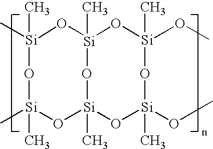
Poly(hydridsilsesquioxane) is formed from a monomer having the structure 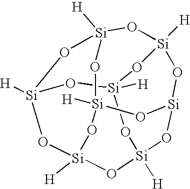
This structure when heated is cured into a crosslinked network.

The curing of poly(silsesquinoxanes) is critical. The temperature of curing MSQ must not exceed 450° C. while the curing temperature of HSQ must not be higher then 210° C. These relatively low curing temperatures are essential insofar as curing at higher temperatures results in the eventual formation of silicon dioxide, which has a dielectric constant of 4, far higher than the dielectric constants of HSQ and MSQ if properly cured.

Poly(silsesquioxanes) are applied to semiconductor devices from a solution of oligomers, containing silanol end groups from monomer hydrolysis. Curing occurs by condensation of the silanol functions, which are no longer detectable after heat treatment at 400° C. These films do not change after several heating cycles to 500° C. The dielectric constant remains stationary at 2.7 and there is no outgassing on annealing for three hours at 450° C. IR spectrum, film thickness and refractive index do not change after heating to 550° C. in vacuum, which indicates very high thermal stability. The material flows during cure and hence the film exhibits rather low stress. In the case of HSQ, curing at 350° C. leads to optimize film properties in terms of dielectric constant, water absorption and low internal stress. The coefficient of thermal expansion of HSQ is 15 ppm/K, independent of the curing temperature. The elastic modulus of cured films is between 9.5 and 12.5 GPa, depending on the curing temperature, which is much higher than for most organic polymers.

In a preferred embodiment the supercritical carbon dioxide employed in the removal of solvents, unreacted monomer and byproducts from cured low k organic polymer films is provided with another solvent. Cosolvents which may be utilized with supercritical carbon dioxide include aldehydes, such as cyclohexanone, ketones, such as methylisobutylketone (MIBK), mesitylene, alcohols having the structural formula ROH, where R is C₄-C₁₀ alkyl or C₅-C₁₀ cycloalkyl, especially butanol, pentanol, cyclopentanol, hexanol, cyclohexanol, cycloalkyls, especially C₅-C₈ cycloalkyls and mixtures thereof.

The volume ratio of supercritical carbon dioxide to cosolvent, given the optional nature of including a cosolvent, is in the range between 0 and about 80% cosolvent, based on the total volume of the supercritical carbon dioxide-cosolvent composition. Thus, in the event that a cosolvent is present, it represents between about 1% and about 80% cosolvent, said percentages being by volume, based on the total volume of the supercritical carbon dioxide-cosolvent composition.

In a more preferred embodiment, the volume ratio of supercritical carbon dioxide to cosolvent is in the range of between 0 and about 50%, based on the total volume of the composition. Therefore, in the preferred embodiment wherein a cosolvent is present, the cosolvent represents between about 1% and about 50% cosolvent, said percentages being by volume, based on the total volume of the composition.

The following examples are given to illustrate the scope of the present invention. Because these examples are given for illustrative purposes only, the present invention should not be deemed limited thereto.

### EXAMPLE 1

A film of b-staged Diels Alder reaction product of a biscyclopentadienone and a polyfunctional acetylene, which is available under the trademark SiLK®, having a thickness of about 0.5 micron was disposed on a silicon wafer. The coated wafer was placed in an oven and heated at 400° C. for 45 minutes. The heating step resulted in the curing of the polymeric film.

The thus cured SiLK® polyarylene was thereupon disposed in an environment whose thermodynamic conditions were 5,000 psi and 80° C. Carbon dioxide was introduced into this environment. The SiLK® film was thus contacted with carbon dioxide in the supercritical state.

At the conclusion of this exposure to carbon dioxide the refractive index was measured on a daily basis utilizing an in-line metrology tool to measure refractive index with ellipsometry over a period of four weeks. The results of these measurements appear in the FIGURE.

### COMPARATIVE EXAMPLE 1

Example 1 was repeated up to the point where the SiLK® polyarylene film was cured. However, the step of contacting the cured SiLK® polyarylene film with supercritical carbon dioxide was omitted. Thereupon the refractive index test was repeated for a period of three weeks. The results of these observations are depicted in the FIGURE.

DISCUSSION OF EXAMPLE 1 AND COMPARATIVE EXAMPLE 1

As demonstrated in the Figure, although the mean refractive index of the cured SiLK® untreated with supercritical carbon dioxide was initially lower than the mean refractive index of the cured SiLK® treated with supercritical carbon dioxide, almost immediately the mean refractive index of the untreated cured SiLK® rose above that of the cured SiLK® contacted with supercritical carbon dioxide. This higher level of untreated cured SiLK® continued over the duration of the test, reaching an asymptotically higher level after three weeks.

This result establishes that treatment with supercritical carbon dioxide effects removal of undesirable byproducts, solvents and uncured monomers. Those skilled in the art are aware that the higher the refractive index, the greater the amount of foreign materials in the polyarylene. For example, if SiLK® is exposed to oxygen-containing materials, the dielectric constant increases. This dielectric constant increase is manifested and correlatable to the increase in mean refractive index.

### COMPARATIVE EXAMPLE 2

Preparation and curing of an approximately 0.5 micron thick film of SiLK® disposed on a silicon wafer was again cured at 400° C. for 45 minutes in accordance with the procedure of Example 1. That sample was analyzed utilizing well-known thermal desorption mass spectrometry (TDMS).

The resultant study demonstrated signal with masses of at 19, 43, 57, 77, 83, 91 and 105, whose units are m/z or mass per unit charge.

### EXAMPLE 2

Comparative Example 2 was repeated. However, at the conclusion of curing, the cured SiLKS polyarylene film on a silicon wafer was contacted with supercritical carbon dioxide in accordance with the procedure of Example 1.

The thus treated sample was analyzed utilizing TDMS in accordance with the procedure utilized in Comparative Example 2. Masses were obtained at 19, 43, 55 and 117.

### COMPARATIVE EXAMPLE 3

Example 2 was repeated. That is, cured SiLK® on a silicon wafer was treated in accordance with the procedure of Example 2. However, at the conclusion of the contact with supercritical carbon dioxide, the cured SiLK® film, disposed on a silicon wafer, was again subjected to elevated temperature, specifically, the sample was heated at 350° C. for 5 minutes. Thereupon, the sample was tested employing TDMS.

Masses for the sample treated with supercritical carbon dioxide, followed by heating at 350° C. and for 5 minutes, were obtained at 19, 43, 57, 69, 77, 83, 91, 105 and 117.

DISCUSSION OF EXAMPLE 2, COMPARATIVE EXAMPLE 2 and COMPARATIVE EXAMPLE 3

The analysis of the TDMS data establish that, independent of the treatment given to the samples, denoted as Comparative Example 2, Example 2 and Comparative Example 3, all of them exhibited a mass at 19. That mass is associated with the presence of H₃O, e.g. protonated water. Masses 43, 55, 57, 69 and 83 are indicative of aliphatic hydrocarbons absorbed by the SiLK polymer (not inherent to the SiLK itself). Masses at 77, 91 and 105 evidence the presence of volatile aromatics. It is noted that the masses at 77, 91 and 105 were found in the samples that were untreated beyond curing or were subjected to supercritical carbon dioxide contact but again heated at 350° C. for 5 minutes, e.g. Comparative Examples 2 and 3. Finally, the mass at 117 evidenced in the supercritical carbon dioxide treated sample as well as the supercritical carbon dioxide treated sample followed heating at a temperature at 350° C. for 5 minutes, e.g. Example 2 and Comparative Example 3, is believed to be associated with another volatile impurity absorbed by the SiLK.

The results obtained from this TDMS study establish that treatment with supercritical carbon dioxide removes undesirable aromatic byproducts generated from the SiLK polymer. It is noted that cured SiLKS polyarylene is an aromatic polymer. Thus, contact with supercritical carbon dioxide removes this undesirable byproduct. The fact that the supercritical carbon dioxide treated sample of Comparative Example 3 evidenced these undesirable masses associated with aromatic residue establishes that high temperature curing results in byproduct formation. Thus, even after treatment with supercritical carbon dioxide, reheating of the sample generates additional amounts of undesirable aromatic byproduct. This test also proves that supercritical CO₂ removes byproduct residues.

The above embodiments and examples are given to illustrate the scope and spirit of the present invention. These embodiments and examples will make apparent, to those skilled in the art, other embodiments and examples. These other embodiments and examples are within the contemplation of the present invention. Therefore, the present invention should be limited only by the appended claims.

1. A process of removing impurities from a cured low dielectric constant organic polymeric film disposed on a semiconductor device comprising disposing a low dielectric constant curable organic polymeric film on an electrically conductive surface of a semiconductor device; curing said organic polymeric film disposed on said semiconductor device; and contacting said cured organic polymeric film with supercritical carbon dioxide and, optionally, one or more solvents.

2. A process in accordance with claim 1 wherein said cured low dielectric constant organic polymeric film is a polyarylene resin.

3. A process in accordance with claim 2 wherein said polyarylene resin is formed from a precursor composition which comprises a compound having cyclopentadiene functional groups, acetylene functional aromatic compounds and/or partially polymerized reaction products of said compounds.

4. A process in accordance with claim 3 wherein said compound having biscyclopentadienone functional groups is a biscyclopentadienone of the formula 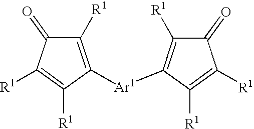
where R¹ is independently hydrogen or an unsubstituted or inertly substituted aromatic moiety; and Ar¹ is an unsubstituted or inertly substituted aromatic moiety; and said acetylene functional aromatic compound is a polyfunctional acetylene of the formula 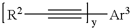
where R² is independently hydrogen or an unsubstituted or inertly substituted aromatic moiety; Ar³ is an unsubstituted or inertly substituted aromatic moiety; and y is an integer at least 3.

5. A process in accordance with claim 4 wherein said precursor composition includes a diacetylene of the formula
R²Ar²R²
where Ar² is an unsubstituted or inertly substituted aromatic moiety; and R² has the meanings given above.

6. A process in accordance with claim 4 wherein said precursor composition comprises a curable polymer of the formula [A]_{w}[B]_{z}[EG]ᵥ where A has the structure 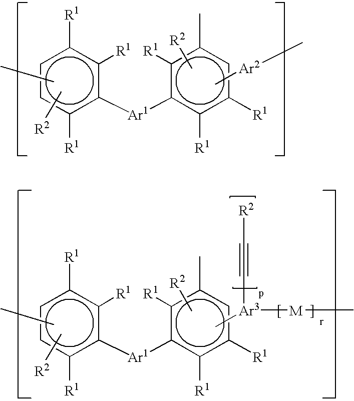
B has the structure
and EG are end groups having a formula 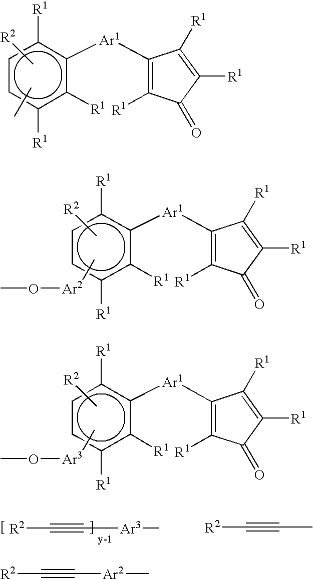
where R¹, R², Ar¹, Ar² and y have the meanings given above; M is a bond; p is the number of unreacted acetylene groups in the given mer unit; r is 1 less than the number of reacted acetylene groups in the given mer unit, with the proviso that p+r=y-1; w is an integer of 0 to about 1,000; z is an integer of 1 to about 1,000; and v is an integer of at least 2.

7. A process in accordance with claim 5 wherein said precursor composition comprises a curable polymer of the formula [A]_{w}[B]_{z}[EG]ᵥ where A has the structure 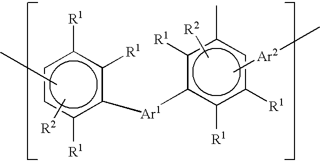
B has the structure 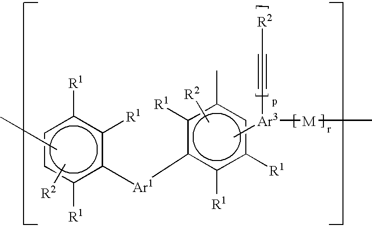
and end groups EG have the formula 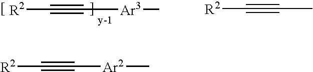
where R¹, R², Ar¹, Ar², Ar³ and y have the meanings given above; M is a bond; p is the number of unreacted acetylene groups in the given mer unit; r is 1 less than the number of reacted acetylene groups in the given mer unit, with the proviso that p+r=y−1, w is an integer of 0 to about 1,000; z is an integer of 1 to about 1,000; and v is an integer of at least 2.

8. A process in accordance with claim 1 wherein said low dielectric constant organic film is a poly(silsesquioxane).

9. A process in accordance with claim 8 wherein said poly(silsesquioxane) is poly(methylsilsesquioxane).

10. A process in accordance with claim 8 wherein said poly(silsesquioxane) is poly(hydridosilsesquioxane).

11. A process in accordance with claim 9 wherein said poly(methylsilsesquioxane) is cured at a temperature of up to about 450° C.

12. A process in accordance with claim 10 wherein said poly(hydridsilsesquioxane is cured at a temperature of up to about 210° C.

13. A process in accordance with claim 1 wherein said organic polymeric film is an interlevel or intralevel dielectric in said semiconductor device.

14. A process in accordance with claim 1 wherein said supercritical carbon dioxide contacts said cured low dielectric constant organic polymeric film with at least one solvent.

15. A process in accordance with claim 14 wherein said solvent is selected from the group consisting of cyclohexanone, methylisobutylketone, mesitylene, alcohols having the structural formula ROH, where R is C₄-C₁₀ alkyl or C₅-C₁₀-cycloalkyl, and C₅-C₈ cycloalkyls.

16. A process in accordance with claim 15 wherein said solvent is present in a concentration in a range of between about 1% and about 80%, said percentages being by volume, based on the total volume of said supercritical carbon dioxide-solvent composition.

17. A process in accordance with Clam 16 wherein said solvent is present in a concentration in a range between about 1% and about 50%.
